(19) United States
(12) Patent Application Publication
(10) Pub. No.: US 2008/0251763 A1
(43) Pub. Date: Oct. 16, 2008

(54) Method For Preparing Phosphor and Phosphor

(76) Inventors: Hisatake Okada, Tokyo (JP); Kazuyoshi Goan, Tokyo (JP); Kazuya Tsukada, Tokyo (JP); Naoko Furusawa, Tokyo (JP); Hideki Hoshino, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/909,969

(22) PCT Filed: Mar. 15, 2006
(86) PCT No.: PCT/JP2006/305108

§ 371 Date: Sep. 27, 2007

(30) Foreign Application Priority Data
Mar. 30, 2005 (JP) 2005-097767

(51) Int. Cl. C09K 11/59

(52) U.S. Cl. 252/301.4 R

(57) ABSTRACT

Disclosed is a method of preparing a phosphor which exhibits superior optical characteristics and improved resistance to deterioration, comprising the steps of subjecting a phosphor precursor obtained by a liquid phase process to a first calcination under an oxygen-containing atmosphere at a prescribed temperature and then subjecting the calcined phosphor precursor to a second calcination at a temperature lower than the temperature of the first calcination.

### TECHNICAL FIELD

The present invention relates to a method for preparing a phosphor and the phosphor, and in particular to a method of preparing a phosphor which is broadly usable in various displays such as a plasma display and various kinds of articles using phosphors and the phosphor.

### TECHNICAL BACKGROUND

Recently, there have been developed display devices employing a new image display system replacing THE CRT (Cathode Ray Tube), such as a liquid crystal display (LCD: Liquid Crystal Display) employing a liquid crystal display, an EL display employing electroluminescence (EL: Electro Luminescence) phenomena and a plasma display employing a plasma display panel (hereinafter, also denoted as PDP: Plasma Display Panel).

Of these, the plasma display can achieve thinning and lightening, a simplified structure and a large-sized screen, and also exhibits a viewable range or a so-called viewing angle of not less than 160 degrees in the horizontal and vertical directions so that clearer images can be viewed from right to left or up and down, as compared to liquid crystal panels. It is also an image display system of fixed picture elements based on dot matrix, which inhibits out-of-color registration or image distortion or enables high quality images even on a big screen.

A PDP used for a plasma display is provided with two plate glass substrates each having an electrode and a large number of discharge cells formed of wails provided between the substrates and a phosphor-coated phosphor layer is formed in the inside of the discharge cell. The thus constituted PDP allows the discharge cells to be selectively discharged by applying a voltage between electrodes, producing vacuum ultraviolet (VUV) rays due to discharge gas enclosed inside the discharge cell and this VUV excites the phosphor to emit visible rays.

Typical manufacturing methods of the above-described phosphor include a solid phase process in which a compound containing elements constituting a parent phosphor and a compound containing an activator element, are mixed in prescribed amounts and then calcined to perform a solid phase reaction and a liquid phase process in which a phosphor raw material solution containing elements constituting a parent phosphor and a phosphor raw material solution containing an activator element are mixed and the obtained precipitate of the phosphor precursor is separated through solid-liquid separation and then calcined.

Of these preparation methods, in the solid phase process, unreacted impurities or reaction by-product salts remain after the solid phase reaction, rendering it difficult to obtain a stoichiomerically highly pure phosphor and producing problems such as reduced yield or emission efficiency of the obtained phosphor. Further, it was difficult, to reduce the phosphor particle size through the solid phase reaction, producing problems such that it was difficult to achieve enhanced emission intensity by increasing a specific surface area.

On the other hand, the liquid phase process is feasible to obtain a homogeneous composite and highly pure phosphor, therefore, the liquid phase process is suitably employed at the present time, comparing to the solid phase process. Examples of a liquid phase process include a reaction crystallization method, a sol-gel method, a coprecipitation method and a hydrothermal synthesis method.

There is known a preparation method of an aluminate phosphor exhibiting enhanced emission luminance and homogeneous composition, as a phosphor preparation method employing a liquid phase process. For instance, a phosphor precursor obtained by mixing a solution containing a metal element cation, an aluminum compound, an organic acid and an organic solvent, followed by drying, is subjected to calcination at a temperature of 1000 to 1700° C. to obtain an aluminate phosphor (as set forth in, for example, patent document 1).

There is also known a preparation method of a phosphor precursor through a liquid phase process, in which raw material components are reacted in a reaction vessel under conditions of a temperature and a pressure lower than their critical points, whereby a solid phosphor precursor is precipitated and is batch-wise obtained. However, this method produced problems that it was highly difficult, due to difference in reaction conditions, to deposit, a phosphor precursor having uniform crystallinity, homogeneous chemical composition and uniform particle size.

There was developed a preparation method of a phosphor precursor and a phosphor as a method to obtain a phosphor having enhanced emission luminance and highly pure and homogeneous composition, in which reaction is undergone under conditions of a temperature and a pressure lower than the critical points with allowing the reactant solution to flow through a tubular reactor to deposit a phosphor precursor, whereby a phosphor precursor and a phosphor are continuously prepared (as set forth in, for example, patent document 2).
Patent document 1: JP-A No. 2001-172621 (hereinafter, the term JP-A refers to Japanese Patent Application Publication)
Patent document 2: JP-A No. 2003-138253

### DISCLOSURE OF INVENTION

### PROBLEM TO BE SOLVED

The phosphor preparation method, as described in patent document 1 is related to a method of preparing an aluminate phosphor by using an aluminum compound, so that application of this preparation method to preparation of silicate phosphors produced problems such that it was greatly difficult to obtain the desired silicate phosphor.

Further, in the phosphor preparation method described in patent document 2, the Reynolds number during reaction was not defined nor was abrasion inside the tubular reactor taken into account. In view thereof, application of this method to preparation of silicate phosphors produces problems that it is very difficult to obtain a desired silicate phosphor from the viewpoint of reactivity.

The present, invention has come into being in light of the foregoing. It is an object of the invention to provide a preparation method of a phosphor exhibiting superior optical characteristics and improved resistance to deterioration and to provide such a phosphor.

### MEANS FOR SOLVING THE PROBLEM

The foregoing object of the invention can be realised by the following constitution:

A preparation method of a phosphor as described in claim 1, wherein the method comprises the steps of subjecting a phosphor precursor obtained by a liquid phase process to a first calcination under an oxygen-containing atmosphere at a prescribed temperature and then subjecting the calcined phosphor precursor to a second calcination at a calcination temperature lower than the temperature of the first calcination.

A preparation method of a phosphor as described in claim 2, wherein the temperature of the first calcination and the temperature of the second calcination are each in the range of 400 to 1400° C.

A preparation method of a phosphor as described in claim 3, wherein the phosphor is a silicate phosphor.

A phosphor as described in claim 4, wherein the phosphor exhibits a ratio of an intensity of an emission excited by a exciting light at a wavelength of 172 nm to that of an emission excited by a exciting light at a wavelength of 146 nm of at least 2.

### EFFECT OF THE INVENTION

The method of the invention, which comprises a first calcination step of calcining a phosphor precursor obtained by a liquid phase under an oxygen-containing atmosphere at a prescribed temperature and a second calcination step of calcining the calcined precursor at a temperature lower than the temperature of the first calcination step, enables to achieve homogeneous crystallization on the surface and in the interior of the phosphor, whereby a phosphor exhibiting superior optical characteristics and enhanced resistance to deterioration can be realised.

### BRIEF DESCRIPTION OF THE DRAWING

FIG. 1 illustrates an example of a Y-shaped reactor used in the preparation method of a phosphor of the invention.

### DESCRIPTION OF DESIGNATION

1: Y-shaped reactor

### PREFERRED EMBODIMENTS OF THE INVENTION

There will be described preferred embodiments of the invention with reference to a drawing. In the following embodiments of the invention, various technically preferred limitations are described but the scope of the invention is by no means limited to these embodiments or to the drawing.

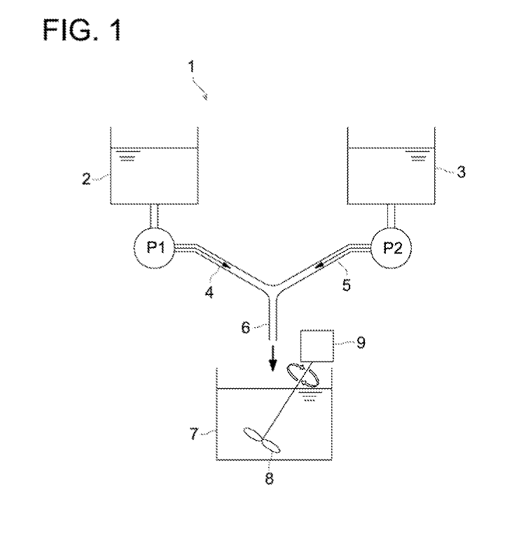

There will be described a preparation method of a phosphor relating to the invention and the phosphor with reference to FIG. 1.

First, there will be described a phosphor in the embodiments of the invention.

The phosphor of the invention, in which the ratio of an emission excited by a light at a wavelength of 172 nm to that by a light at a wavelength of 146 nm is preferably two or more, refers to a phosphor which is prepared by subjecting a phosphor precursor obtained by mixing a solution or dispersion containing a silicon compound and a solution containing a metal element, that is, a phosphor precursor obtained through a liquid phase process to plural calcination treatments under prescribed conditions.

In the invention, there is applicable any liquid phase process enabling to obtain a precursor of a phosphor.

The foregoing solution or dispersion containing a silicon compound comprises a silicon compound and a solvent capable of dissolving or dispersing the silicon compound.

The silicon compound is a silicon-containing solid and, for example, silicon dioxide (hereinafter, also denoted as silica), a single substance of silicon and the like are applicable.

Silica is preferred as a silicon compound usable invention and typical examples of silica include a gas phase-processed silica, a wet silica and a colloidal silica.

The silicon compound preferably exhibits a specific BET (Brunauer Emmett Teller) surface area of not less than 50 m²/g, more preferably not less than 100 m²/g, and still more preferably not less than 200 m²/g.

The silicon compound preferably exhibits a primary particle size or a secondary aggregated particle size of not more than 0.5 μm, and more preferably not more than 0.1 μm.

In the dispersion containing a silicon compound, the particle size or the dispersion state of the silicon compound is preferably controlled in advance. Specific examples of a controlling method include controlling the stirring rotation speed and the stirring time for a dispersion containing a silicon compound but dispersing a silicon compound-containing dispersion by an ultrasonic is suitably employed.

There may optionally be added surfactants or diapersants in controlling the particle size or the dispersion state. There may also used colloidal silica obtained by controlling a particle size or dispersion state. Colloidal silica is preferably an anionic one and the particle size thereof is not more than 1 μm, preferably not more than 0.5 μm, and more preferably not more than 0.1 μm.

When conducting control, the temperature of a dispersion is not more than 50° C. to prevent an increase of viscosity due to re-aggregation of the silicon compound, preferably not more than 30° C., and more preferably not more than 10° C. The aggregated particle size is typically not more than 1 μm, preferably not more than 0.5 μm, and more preferably not more than 0.1 μm in terms of preparation of a minute phosphor.

The silicon compound is dispersed preferably using a solvent such as water, alcohols or a mixture thereof. Alcohols are not specifically limited and may be any alcohol capable of dispersing silicon compounds. Examples thereof include methanol, ethanol, isopropanol, propanol and butanol but ethanol is suitable in terms of dispersibility of the silicon compound.

In the invention, the silicon compound is usable in a state of solution. A solvent for a solution of the silicon compound is preferably an aqueous alkaline solution.

The metal element in the embodiments of the invention is not specifically limited and airy metal element which can constitute a silicate phosphor by being subjected to a calcination treatment is usable in the invention, but at least one metal element selected from Zn, Mn, Mg, Ca, Sr, Ba, Y, Zr, Al, Ga, La, Ce, Su and Tb is preferred. For instance, in the case of preparing a green phosphor (e.g., Zn₂SiO₄:Mn²⁺), one containing Zn and Mn is used.

In the embodiments of the invention, a metal element may be in the form of a solid substantially insoluble in the used solvent, or may be in the form of a chloride or a nitrate soluble in the used solvent.

There may be used a precipitant for the silicate phosphor described above.

Organic acids and an alkali hydroxide are suitably used as a precipitant. Organic acids include those containing a —COOH group, for example, oxalic acid, formic acid, acetic acid and tartaric acid. Specifically, oxalic acid is preferably used, which easily reacts with cations of Zn, Mn, Mg, Ca, Sr, Ba, Y, Zr, Al, Ga, La, Ce, Eu and Tb to precipitate as an oxalate.

As an alkali hydroxide usable is one which contains a —OH group or one which gives rise to a —OH group upon reaction with water or upon hydrolysis and examples thereof include ammonia, sodium hydroxide, potassium hydroxide and urea. Of these, ammonia is suitable, since if contains no alkali metal.

There will be described a method of preparing a phosphor in the embodiments of the invention, with reference to FIG. 1.

In the invention, the method of preparing a phosphor comprises a precursor forming step to form a precursor of a

phosphor and a calcination step to calcine; the precursor, obtained in the precursor forming step.

The individual steps will be detailed with an example of preparation of a silicate phosphor.

There will be described a precursor forming step by using a silicon compound dispersion.

In the precursor forming step, a precursor of a phosphor is formed by mixing a silicon compound-containing dispersion and a metal-containing solution.

In the embodiments of the invention, there are applicable commonly known mixing methods, such as a batch system, a continuous system and an external circulation mixing, for instance, a mixing method by stirring is suitably employed in terms of control and instrument cost.

In view of dispersibility of a silicon compound, it is preferred to add another solution to a silicon compound-containing dispersion as a mother liquor with stirring or it is also preferred that while a silicon compound-containing dispersion is externally circulated, another solution is added to a mixer provided on the way of the external circulating path.

A method of adding a precipitant with mixing is not specifically limited. For instance, it is preferred that while stirring a silicon compound-containing dispersion as a mother liquor, the silicon compound-containing dispersion and another solution is simultaneously added by double jet addition. It is also preferred that while a silicon compound-containing dispersion as a mother liquor is externally circulated, the silicon compound-containing dispersion and another solution are simultaneously added by double jet addition to a mixer provided on the way of the external circulating path.

A solution may be added onto the surface of the mother liquor or added into the inside of the mother liquor but addition into the inside of the mother liquor is preferred to achieve homogeneous-mixing. The stirring Reynolds number is not less than 1,000, preferably not less than 3,000 and more preferably not less than 5,000.

Mixing a silicon compound-containing dispersion and a solution containing a metal element capable of constituting a silicate phosphor upon calcination is conducted in a Y-shaped reactor 1, which plural paths form a Y-shape in the planar view, as shown in FIG. 1.

The Y-shape reactor 1 is provided with a first tank 2 for retaining phosphor raw material solution A and a second tank 3 for retaining phosphor raw material solution B. The first tank 2 and the second tank 3 are each connected to the end of each of first path 4 and second path 5. Pumps P1 and P2, which supply phosphor raw material solutions A and B, respectively, are provided in the mid-course of the first path 4 and the second path 5. The other ends of the paths 4 and 5 are connected to a third path 6 through a connecting section C. In the connecting section C, the respective phosphor raw material solutions A and B, which are supplied through paths 4 and 5, collide and are mixed with each other,

A ripening vessel 7 is provided below the discharge opening of the third path 6 and a mixed solution is continuously supplied thereto. The ripening vessel 7 is provided with a stirring blade 8 to stir the mixed solution retained in the vessel and the stirring blade 8 is connected to a driver 9 as a motive power source.

In the Y-shape reactor 1, the respective paths 4, 5 and 6 are usually formed of stainless steel. In the case of a precursor of high hardness, there tends to be contaminated powdery stainless steel which is formed of abrasion of stainless steel constituting the respective paths 4, 5 and 6. When a precursor contaminated with stainless steel powder is subjected to a calcination treatment, Na, Fe, Cr, Mi, Mo, Ti, Nb or the like is contaminated in the interior of the phosphor crystals, often resulting in reduced emission efficiency.

To prevent contamination of various kinds of metals, the inner wall of the respective paths 3, 4 and 5 is preferably coated with a resin such as Teflon (trade name), and the path itself is formed preferably of resin such as PP (polypropylene).

The Y-shaped reactor 1 was used as a reactor in the embodiments of the invention, but reactors usable in the invention are not limited thereto. There is also usable a T-shape preparation apparatus, which differs in the form of the path and forms a T-shape in the planar view.

The Reynolds number after collision is preferably not less than 3,000, more preferably not less than 5,000 and still more preferably not less than 10,000. The liquid supply time is preferably not less than 0.001 sec., more preferably not less than 0.01 sec, and still more preferably not less than 0.1 sec.

The Reynolds number (Re) is a dimensionless number, represented by the following formula (1):

Re=ρDU/η (1)

where D is a characteristic length of a body in the flow, U is a fluid velocity, ρ is a fluid density and η is a fluid viscosity.

In the process of forming a precursor of a phosphor, it is preferred that particle size control is appropriately performed, and the formed phosphor precursor is recovered through filtration, distillation drying, centrifugal separation or the like and further subjected to washing or desalting to remove byproduct salts or impurities.

After desalting, drying may be performed. A drying step is conducted preferably after a desalting step. There are applicable a drying method using evaporation and a spray dry method in which drying is performed with granulating.

The drying temperature is not specifically limited but a temperature near the evaporation temperature of the solvent used therein is preferred. Drying and calcination are concurrently performed at an excessively high temperature and a phosphor is obtained without being subjected to the followed calcination treatment. Specifically, the drying temperature is preferably in the range of from 20 to 300° C., and more preferably in the range of from 90 to 200° C.,

The average particle size of the obtained precursor is preferably not more than 1 μm, more preferably not more than 0.8 μm, and still more preferably not more than 0.5 μm. The coefficient of variation which is calculated by dividing the standard deviation by the average particle size is preferably not more than 50%, more preferably not more than 30%, and still more preferably not more than 15%.

Next, there will be described the calcination step.

In the embodiments of the invention, a silicate phosphor is obtained by subjecting a precursor of the phosphor to plural calcination treatments. The conditions in the calcination treatment, (hereinafter, also denoted as calcination condition) will be described below.

The calcination conditions include a calcination atmosphere, a calcination temperature, the times of calcinations and a calcination time. The phosphor preparation method of the invention is featured in that the method comprises the steps of subjecting a phosphor precursor obtained by a liquid phase process to a first calcination treatment in an oxygen-containing atmosphere at a prescribed temperature and subjecting the calcined phosphor precursor to a second calcination treatment at a temperature lower than the temperature of the first calcination.

The first calcination is performed under an oxygen-containing atmosphere and is preferably performance under an aerated aero-atmosphere in terms of cost. The calcination temperature is preferably in the range of from 400 to 1400° C. Depending on the targeted phosphor, it is specifically preferred to perform calcination at 1300 to 1300° C. The calcination time is preferably in the range of 0.5 to 40 hrs. Calcination time depends on thea calcination temperature but it is specifically preferred to perform calcination at a temperature of from 1200 to 1300° C. within a calcination time of from 0.5 to 40 hrs.

The calcination atmosphere in the second calcination step is preferably an inert gas atmosphere, typified by a nitrogen atmosphere, which may optionally be combined with an aerial or oxygen atmosphere or a reducing atmosphere. Methods for realizing a reducing atmosphere include introduction of a block of graphite into the boat-shaped calcination vessel filled with a phosphor precursor and calcination in a nitrogen/hydrogen atmosphere or a rare gas/hydrogen atmosphere. The calcination atmosphere may contain water vapor.

The calcination temperature of the second calcination, which is lower that that of the first calcination is in the range of from 400 to 1400° C. The second calcination is conducted in the range of from the first calcination temperature to a temperature of 100-200° C. lower than the first calcination temperature. Evaporation of zinc from a crystal is inhibited within this temperature range even when performing calcination in a calcination; atmosphere combined with a reducing atmosphere.

The second calcination is performed preferably over a period of 0.5 to 40 hrs. In the invention, the second calcination is performed preferably in a nitrogen atmosphere over a period of 2 to 5 hrs at a temperature in the range of a temperature equivalent to the first calcination temperature to a temperature of 100° C. lower than the first calcination temperature.

A calcined silicate phosphor may optionally be subjected to a dispersing treatment, a washing treatment, a drying treatment or a classifying treatment.

A desired phosphor can be prepared according to the foregoing preparation method. The thus obtained phosphor is suitable for devices such as a phosphor lamp, a phosphor display tube and a plasma display; displays such as a phosphor paint, an ash tray, a guide plate and induction material; and phosphor-used materials such as a seal, stationery, out-door goods and safety signals.

### EXAMPLES

There will be described phosphors and a preparation method thereof.

In Examples 1-3, phosphor precursors were synthesized using Zn₂SiO₄:Mn²⁺ as raw material and the obtained precursors were calcined under different conditions to obtain phosphors 1, 2 and 3. The obtained phosphors 1, 2 and 3 were each evaluated with respect to optical characteristics and deterioration resistance, based on relative emission intensity and persistence time.

### Example 1

First, there will be described preparation of a precursor.

Colloidal silica (PL-3, produced by Fuso Kagaku Kogyo Co., Ltd.) containing 45 g of silicon dioxide, 219 g of 28% ammonia water and pure water were mixed and made to 1500 ml to obtain solution A.

424 g of zinc nitrate hexahydrate (produced by Kanto Kagaku Co., Ltd., purity: 99.0%) and 21.5 g of manganese nitrate hexahydrate (produced by Kanto Kagaku Co., Ltd., purity: 98.0%) were dissolved in pure wafer and made to 1500 ml to obtain solution B.

The obtained solutions A and B were each retained in a tank 2 and a tank 3 of the Y-shaped reactor shown in FIG. 1 and maintained at a temperature of 40° C., These solutions A and B were each supplied to a ripening vessel 7 by using pumps 1 and 2 at a rate of 1800 ml/min and a precipitate obtained in the reaction was added with pure water and separated by pressure filtration, and further dried for 12 hrs. at 100° C. to obtain a dried phosphor precursor.

Subsequently, the dried phosphor precursor was calcined in the first calcination step in an aerial atmosphere at 1280° C. for 3 hrs. Further, in the following second calcination step, calcination was performed in a 100% nitrogen atmosphere at 1240° C. for 3 hrs. to obtain phosphor 1.

### Example 2

The dried phosphor precursor obtained in Example 1 was calcined in an aerial atmosphere at 1280° C. for 3 hrs. in the first calcination step. Further, in the following second calcination step, calcination was performed in a 100% nitrogen atmosphere at 1280° C. for 3 hrs. to obtain phosphor 2.

### Comparative Example 1

The dried phosphor precursor obtained in Example 1 was calcined in a 100% nitrogen atmosphere at 1280° C. for 3 hrs. in the first calcination step. Further, in the following second calcination step, calcination was performed in a 100% nitrogen atmosphere at 1280° C. for 3 hrs. to obtain phosphor 3.

Next, there will be described evaluation of phosphors.

Evaluation of phosphors was conducted by employing, as an evaluation measure, emission intensity of the foregoing phosphors 1, 2 and 3,

The emission intensity was determined as follows. The obtained phosphors 1, 2 and 3 were each placed into the inside of a vacuum bath of 0.1 to 1.5 Pa and exposed to a vacuum ultraviolet ray (VUV) by using 146 nm exciting light of an excimer lamp (UER 20H-146A, produced by Ushio Denki Co.). The peak intensity of light emitted on exposure was measured by using a detector (CS-200, produced by Konica Minolta Sensing Co.). The measured emission intensity (cd/m²), designated as initial luminance at 146 nm, is shown in Table 1.

The obtained phosphors 1, 2 and 3 were each placed into the inside of a vacuum bath of 0.1 to 1.5 Pa and exposed to VUV by using 172 nm exciting light of an excimer lamp (UER 20H-172A, produced by Ushio Denki Co.). The peak intensity of light emitted on exposure was measured by using a detector (CS-200, produced by Konica Minolta Sensing Co.). The measured emission intensity (cd/m²), designated as initial luminance at 172 nm, is shown in Table 1.

The obtained phosphors 1, 2 and 3 were each introduced to the inside a vacuum bath of 0.1 to 1.5 Pa and continuously exposed to VUV by using 146 nm exciting light of an excimer lamp (UER 20H-146A, produced by Ushio Denki Co.) over a period of 500 hrs. The peak intensity of light emitted on exposure was measured by using a detector (CS-200, produced by Konica Minolta Sensing Co.). The measured emission intensity (cd/m²), designated as luminance at 146 nm after 500 hr., is shown in Table 1.

The obtained phosphors 1, 2 and 3 were each introduced to the inside of a vacuum bath of 0.1 to 1.5 Pa and continuously exposed to VUV by using 172 nm exciting light of an excimer lamp (UER 20H-172A, produced by Ushio Denki Co.) over a period of 500 hrs. The peak intensity of light emitted on exposure was measured by using a detector (CS-200, produced by Konica Minolta Sensing Co.). The measured emission intensity (cd/m²), designated as luminance, at 172 nm after 500 hr., is shown in Table 1.

TABLE 1

| | Initial | | Luminance | | |
|---|---|---|---|---|---|
| | Luminance | | after 500 hr. | | |
| | 146 nm | 172 nm | 146 nm | 172 nm | |
| Phosphor | 756 cd/m² | 1535 cd/m² | 695 cd/m² | 1525 cd/m² | Inv. |
| 1 | | | | | |
| Phosphor | 735 cd/m² | 1480 cd/m² | 665 cd/m² | 1450 cd/m² | Inv. |
| 2 | | | | | |
| Phosphor | 712 cd/m² | 1314 cd/m² | 619 cd/m² | 1285 cd/m² | Comp. |
| 3 | | | | | |

From the results, it was shown that comparing phosphors 1 and 2 of Examples 1 and 2 with phosphor 3 of Example 3, phosphors 1 and 2, in which the ratio of an emission intensity by exciting light at a wavelength of 172 nm to that by exciting light at a wavelength of 146 nm was not less than 2, exhibited superior emission characteristics and enhanced resistance to deterioration as well as higher emission intensities before and after continuous exposure to VUV and reduced decrease of luminance after continuous exposure to VUV.

It was further shown from comparison of phosphor 1 of Example 1 with phosphor 2 of Example 2 that phosphor 1, which was calcined in an oxygen containing atmosphere of the first calcination step, exhibited higher emission intensities before and after continuous exposure to VUV and less decrease of luminance after continuous exposure to VUV.

As can be seen from the foregoing, the phosphor preparation method relating to the invention, which was comprised, of the steps of subjecting a phosphor precursor obtained by a liquid phase process to a first calcination under an oxygen-containing atmosphere at a prescribed calcination temperature and subjecting the calcined phosphor precursor to a second calcination at a calcination temperature lower than the calcination temperature of the first calcination, enabled to achieve homogeneous crystallization on the surface and in the interior of the phosphor, whereby a phosphor exhibiting superior optical characteristics and enhanced resistance to deterioration were realized.

What is claimed is;

1. A method of preparing a phosphor comprising the steps of:
subjecting a phosphor precursor obtained by a liquid phase process to a first calcination under an oxygen-containing atmosphere at a prescribed temperature and
subjecting the calcined phosphor precursor to a second calcination at a temperature lower than the temperature of the first calcination.

2. The method as claimed in claim 1, wherein the temperature of the first calcination and the temperature of the second calcination are each in the range of 400 to 1400° C.

3. The method as claimed in claim 1 or 2, wherein the phosphor is a silicate phosphor.

4. A phosphor prepared by a method as claimed in any one of claims 1 to 3, wherein the phosphor exhibits at least 2 of a ratio of an intensity of an emission excited by a exciting light at a wavelength of 172 nm to that of an emission excited by a exciting light at a wavelength of 146 nm.
